(19) United States
(12) Patent Application Publication
(10) Pub. No.: US 2026/0112194 A1
(43) Pub. Date: Apr. 23, 2026

(54) METHOD AND SYSTEM FOR AUTOMATIC DETECTION OF SELECTION ELEMENTS IN DIGITIZED DOCUMENTS

(71) Applicant: HCL Technologies Limited, New Delhi (IN)

(72) Inventor: Anil Kumar Lenka, Bengaluru (IN)

(21) Appl. No.: 19/089,045

(22) Filed: Mar. 25, 2025

(30) Foreign Application Priority Data
Oct. 21, 2024 (IN) 202411079813

(51) Int. Cl. G06V 30/414; G06V 10/24; G06V 10/28; G06V 10/30; G06V 10/34; G06V 10/44; G06V 10/764; G06V 10/82; G06V 10/98

(52) U.S. Cl. CPC G06V 30/414; G06V 10/443; G06V 10/764; G06V 10/82; G06V 10/993; G06V 10/243; G06V 10/28; G06V 10/30; G06V 10/34

(57) ABSTRACT

This disclosure relates to method and system for automatic detection of selection elements in digitized documents. The method includes receiving a document image comprising a plurality of elements. The method may further include extracting a plurality of contours corresponding to the plurality of elements in the document image using a contour extraction technique. The method may further include eliminating a first set of false positive selection elements from the plurality of contours using one or more contour filters to obtain a plurality of filtered contours. The method may further include determining, via a Convolution Neural Network (CNN) model, the plurality of selection elements and a selection state corresponding to each of the plurality of selection elements.

### TECHNICAL FIELD

This disclosure relates generally to detection of selection elements, and more particularly to method and system for automatic detection of selection elements in digitized documents.

### BACKGROUND

Digitization of documents to an electronic format (i.e., document images) is a growing need around the world. Conventional Optical Character Recognition (OCR) algorithms may successfully detect letters and numbers in the document images. However, the conventional OCR algorithms may fail to identify selection elements (for example, checkboxes, radiobuttons, and the like) from the document images. Additionally, the conventional OCR algorithms may fail to identify a selection state (such as selected state or unselected state) of a selection element due to various factors (for example, format, size, shape, and the like).

Moreover, the detection of selection elements may be a very challenging process due to variations of the document images in terms of factors such as quality, background, illuminations and view angles, and other error-prone settings. The detection of selection elements may require user input including either manually drawn bounding boxes around the selection elements or a matching template for comparison/reference. Variation in the resolution, noise levels, and quality of the document images captured by different devices (for example, scanners, mobile phones, etc.) may also affect accuracy of the detection. Additionally, different formatting in different documents may prevent reliable detection of the selection. For example, selection elements in different documents may be varying in proximity from each other, varying in size, orientation, and/or shapes, varying in selection indicators (tick mark, cross mark, dot, etc.), overlapped by other elements (text, lines, etc.), or misidentified as some other character (e.g., a radiobutton may be identified as a character “∘” or “0”).

Thus, the present invention is directed to overcome one or more limitations stated above or any other limitations associated with the known arts.

### SUMMARY

In one embodiment, a method for automatic detection of selection elements in digitized documents is disclosed. In one example, the method may include receiving a document image including a plurality of elements. The plurality of elements may include a plurality of selection elements. Each of the plurality of selection elements may be one of a checkbox or a radio button. The method may further include extracting a plurality of contours corresponding to the plurality of elements in the document image using a contour extraction technique. The method may further include eliminating a first set of false positive selection elements from the plurality of contours using one or more contour filters to obtain a plurality of filtered contours. The method may further include determining, via a Convolution Neural Network (CNN) model, the plurality of selection elements and a selection state corresponding to each of the plurality of selection elements, from the plurality of filtered contours. The selection state may correspond to one of selected or unselected.

In one embodiment, a system for automatic detection of selection elements in digitized documents is disclosed. In one example, the system may include a processor and a computer-readable medium communicatively coupled to the processor. In one example, the computer-readable medium may store processor-executable instructions, which, on execution, may cause the processor to receive a document image including a plurality of elements. The plurality of elements may include a plurality of selection elements. Each of the plurality of selection elements may be one of a checkbox or a radio button. The processor-executable instructions, on execution, may further cause the processor to extract a plurality of contours corresponding to the plurality of elements in the document image using a contour extraction technique. The processor-executable instructions, on execution, may further cause the processor to eliminate a first set of false positive selection elements from the plurality of contours using one or more contour filters to obtain a plurality of filtered contours. The processor-executable instructions, on execution, may further cause the processor to determine, via a Convolution Neural Network (CNN) model, the plurality of selection elements and a selection state corresponding to each of the plurality of selection elements, from the plurality of filtered contours. The selection state may correspond to one of selected or unselected.

In one embodiment, a non-transitory computer-readable medium storing computer-executable instructions for determining crop attributes through aerial images is disclosed. In one example, the stored instructions, when executed by a processor, may cause the processor to receive a document image including a plurality of elements. The plurality of elements may include a plurality of selection elements. Each of the plurality of selection elements may be one of a checkbox or a radio button. The operations may further include extracting a plurality of contours corresponding to the plurality of elements in the document image using a contour extraction technique. The operations may further include eliminating a first set of false positive selection elements from the plurality of contours using one or more contour filters to obtain a plurality of filtered contours. The operations may further include determining, via a Convolution Neural Network (CNN) model, the plurality of selection elements and a selection state corresponding to each of the plurality of selection elements, from the plurality of filtered contours. The selection state may correspond to one of selected or unselected.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for automatic detection of selection elements in digitized documents, in accordance with some embodiments.

FIG. 2 illustrates a functional block diagram of a system for automatic detection of selection elements in digitized documents, in accordance with some embodiments.

FIG. 3 illustrates a flow diagram of an exemplary process for automatic detection of selection elements in digitized documents, in accordance with some embodiments.

FIG. 4 illustrates a detailed exemplary control logic for automatic detection of selection elements in digitized documents, in accordance with some embodiments.

FIG. 5 illustrates an exemplary document image, in accordance with an embodiments.

FIG. 6 illustrates contour extraction in an exemplary portion of a document image, in accordance with an embodiment.

FIG. 7 illustrates element detection through bounding boxes in an exemplary portion of a document image, in accordance with an embodiment.

FIG. 8 illustrates contour filtering in an exemplary portion of a document image, in accordance with an embodiment.

FIG. 9 illustrates detection of selection elements in an exemplary portion of a document image, in accordance with an embodiment.

FIG. 10 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

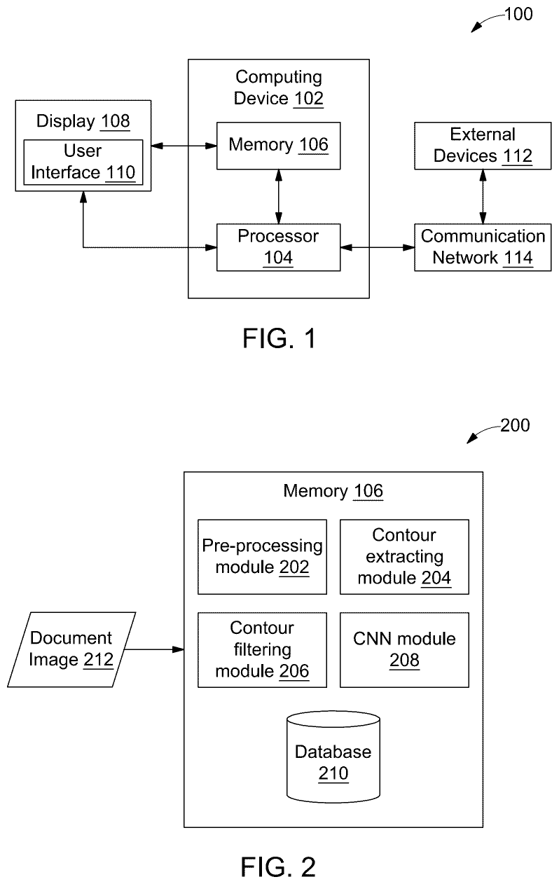

Referring now to FIG. 1, an exemplary system 100 for automatic detection of selection elements (e.g., checkboxes or radio buttons) in digitized documents is illustrated, in accordance with some embodiments. A digitized document may be a digital version (e.g., an image or an electronic document) of a physical document. The system 100 may include a computing device 102 (for example, a server, a desktop, a laptop, a notebook, a netbook, a tablet, a smartphone, a mobile phone, or any other computing device), in accordance with some embodiments. The computing device 102 may automatically detect selection elements in the digitized documents using contour filtering techniques and a Convolutional Neural Network (CNN) model.

As will be described in greater detail in conjunction with FIGS. 2-10, the computing device 102 may receive a document image including a plurality of elements. The plurality of elements may include a plurality of selection elements. Each of the plurality of selection elements may be one of a checkbox or a radio button. The computing device 102 may further extract a plurality of contours (a set of points (or pixels) defining boundary of an entity) corresponding to the plurality of elements in the document image using a contour extraction technique. The computing device 102 may further eliminate a first set of false positive selection elements from the plurality of contours using one or more contour filters to obtain a plurality of filtered contours. The computing device 102 may further determine, via a CNN model, the plurality of selection elements and a selection state corresponding to each of the plurality of selection elements, from the plurality of filtered contours. The selection state may correspond to one of selected or unselected.

In some embodiments, the computing device 102 may include one or more processors 104 and a memory 106. The memory 106 may store instructions that, when executed by the one or more processors 104, may cause the one or more processors 104 to automatically detect the selection elements in digitized documents, in accordance with aspects of the present disclosure. The memory 106 may also store various data (for example, a plurality of document images, contours, locations, and selection states of a plurality of selection elements, CNN model parameters, and the like) that may be captured, processed, and/or required by the system 100. The memory 106 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

The system 100 may further include a display 108. The system 100 may interact with a user via a user interface 110 accessible via the display 108. The system 100 may also include one or more external devices 112. In some embodiments, the computing device 102 may interact with the one or more external devices 112 over a communication network 114 for sending or receiving various data. The external devices 112 may include, but may not be limited to, a remote server, a digital device, or another computing system. By way of an example, the digital device may be an image capturing device (such as a camera) that provides the document images to the computing device 102.

Referring now to FIG. 2, a functional block diagram of a system 200 for automatic detection of selection elements in digitized documents is illustrated, in accordance with some embodiments. FIG. 2 is explained in conjunction with FIG. 1. The system 200 may be analogous to the system 100. The system 200 may include, within the memory 106, a pre-processing module 202, a contour extracting module 204, a contour filtering module 206, and a CNN module 208.

The pre-processing module 202 may receive a document image 212 including a plurality of elements. The plurality of elements may include a plurality of selection elements (for example, a checkbox or a radio button). The pre-processing module 202 may include a quality assessment model. Further, the pre-processing module 202 may determine, via the quality assessment model, a quality category of the document image 212 based on a set of quality parameters of the document image 212. The quality category may be one of a good quality image, a medium quality image, or a bad quality image. By way of an example, the set of quality parameters may include, but may not be limited to, Dots Per Inch (DPI), blur, sharpness, contrast, colour, resolution, and noise.

To determine the quality category of the document image 212, the pre-processing module 202 may determine, via the quality assessment model, the set of quality parameters for the document image 212. A value for each of the set of quality parameters of the document image 212 may be calculated. Further, the pre-processing module 202 may compare the set of quality parameters with a corresponding set of quality threshold values. The value of each of the set of quality parameters of the document image 212 may be compared with a corresponding quality threshold value. The set of quality threshold values may be predefined. For example, the calculated value of the DPI of the document image 212 may be compared with a predefined threshold value of the DPI.

Based on comparison of the set of quality parameters with the corresponding set of quality threshold values, the pre-processing module 202 may classify the document image 212 into one of the good quality image, the medium quality image, or the bad quality image. By way of an example, for each of the set of quality parameters, an upper quality threshold value and a lower quality threshold value may be predefined. If a calculated quality parameter is greater than the upper quality threshold value, the document image 212 may be classified as a good quality image. If the calculated quality parameter is less than the upper quality threshold value and greater than the lower quality threshold value, the document image 212 may be classified as a medium quality image. If the calculated quality parameter is less than the lower quality threshold value, the document image 212 may be classified as a bad quality image.

Further, the pre-processing module 202 may pre-process the document image 212 using one or more pre-processing techniques based on the quality category to obtain a pre-processed document image. The pre-processing techniques may include, but may not be limited to, gray scale conversion, noise reduction and smoothening, skew detection and correction, morphological open operation, applied thresholding, or the like. Further, the pre-processing module 202 may send the pre-processed document image to the contour extracting module 204.

Further, the contour extracting module 204 may extract a plurality of contours corresponding to the plurality of elements in the pre-processed document image using the contour extraction technique to obtain a first marked image. It may be noted that each of the plurality of contours may include a set of points (or pixels) that defines an element. In other words, a contour may constitute a boundary of a corresponding element. Thus, in the first marked image, each of the plurality of contours may highlight the boundary (or outline) of the corresponding element. In some embodiments, the contour extracting module 204 may identify a location of each of the plurality of contours. The location may correspond to position coordinates of each of the corresponding plurality of elements. In other words, the plurality of elements may be localized. Further, the contour extracting module 204 may send the first marked image to the contour filtering module 206.

It should be noted that the first marked image includes the plurality of contours corresponding to the plurality of elements in the document image 212. Thus, the plurality of contours may include contours corresponding to the plurality of selection elements as well as contours corresponding to a plurality of non-selection elements (such as text characters, symbols, images, etc.). The contour filtering module 206 may eliminate a first set of false positive selection elements from the plurality of contours in the first marked image using one or more contour filters to obtain a plurality of filtered contours (i.e., a plurality of localized selection elements) in a second marked image. The first set of false positive selection elements may include one or more of the plurality of non-selection elements. By way of an example, the one or more contour filters may include, but may not be limited to, at least one of a polygonal curve count filter, a bounding box aspect ratio filter, a bounding box size filter, a bounding box area filter, a bounding box orientation filter, a nearest neighbour bounding box elimination filter, an inner contour removal filter, and a dynamic area filter.

To eliminate the first set of false positive selection elements, the contour filtering module 206 may sequentially apply the one or more contour filters to each of the plurality of elements. In other words, each of the one or more contour filters may be applied one at a time in a predefined sequence to the plurality of elements in the first marked image. Further, the contour filtering module 206 may identify the first set of false positive selection elements from the plurality of elements based on a predefined threshold of each of the one or more contour filters. Further, the contour filtering module 206 may eliminate the first set of false positive selection elements to obtain the plurality of filtered contours. It should be noted that the plurality of filtered contours in the second marked image may include contours corresponding to the plurality of selection elements and a second set of false positive selection elements. The second set of false positive selection elements may include unsuccessfully eliminated non-selection elements. Further, the contour filtering module 206 may send the second marked image to the CNN module 208.

the CNN module 208 may include a CNN model. The CNN module 208 may determine, by the CNN model, the plurality of selection elements and a selection state corresponding to each of the plurality of selection elements, from the plurality of filtered contours in the second marked image. The selection state may correspond to one of selected or unselected. The selected selection state may be indicative of the selection element being selected (for example, by a tick mark, a dot, a cross, etc.). Additionally, the CNN module 208 may eliminate, via the CNN model, the second set of false positive selection elements from the plurality of filtered contours in the second marked image, prior to determining the plurality of selection elements.

It should be noted that all such aforementioned modules 202-208 may be represented as a single module or a combination of different modules. Further, as will be appreciated by those skilled in the art, each of the modules 202-208 may reside, in whole or in parts, on one device or multiple devices in communication with each other. In some embodiments, each of the modules 202-208 may be implemented as dedicated hardware circuit comprising custom application-specific integrated circuit (ASIC) or gate arrays, off-the-shelf semiconductors such as logic chips, transistors, or other discrete components. Each of the modules 202-208 may also be implemented in a programmable hardware device such as a field programmable gate array (FPGA), programmable array logic, programmable logic device, and so forth. Alternatively, each of the modules 202-208 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for automatic detection of selection elements in digitized documents. For example, the exemplary system 100 and the associated computing device 102 may automatically detect selection elements in digitized documents by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

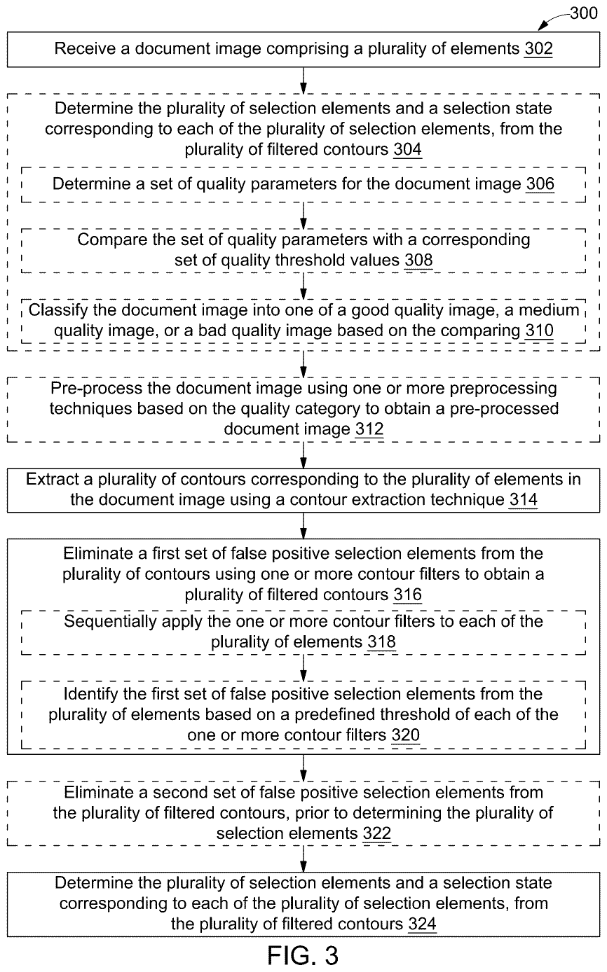

Referring now to FIG. 3, an exemplary process 300 for automatic detection of selection elements is depicted via a flowchart, in accordance with some embodiments. FIG. 3 is explained in conjunction with FIGS. 1 and 2. The process 300 may be implemented by the computing device 102 of the system 100. The process 300 may include receiving, by a pre-processing module (for example, the pre-processing module 202), a document image (for example, the document image 212) including a plurality of elements, at step 302. The plurality of elements may include a plurality of selection elements. By way of an example, each of the plurality of selection elements may be one of a checkbox, a radio button, or the like.

Further, the process 300 may include determining, by the pre-processing module via a quality assessment model, a quality category of the document image based on a set of quality parameters of the document image, at step 304. In an embodiment, the quality category may be one of a good quality image, a medium quality image, or a bad quality image. By way of an example, the set of quality parameters may include, but may not be limited to, DPI, blur, sharpness, contrast, colour, resolution, and noise. The step 304 of the process 300 may include determining, by the pre-processing module via the quality assessment model, a set of quality parameters for the document image, at step 306. Further, the step 304 of the process 300 may include comparing, by the pre-processing module, the set of quality parameters with a corresponding set of quality threshold values, at step 308. Further, the step 304 of the process 300 may include classifying, by the pre-processing module, the document image into one of the good quality image, the medium quality image, or the bad quality image based on the comparing, at step 310.

Further, the process 300 may include pre-processing, by the pre-processing module via the quality assessment model, the document image using one or more preprocessing techniques based on the quality category to obtain a pre-processed document image, at step 312. By way of an example, the one or more preprocessing techniques may include, but may not be limited to, gray scale conversion, noise reduction and smoothening, skew detection and correction, morphological open operation, and applied thresholding. Further, the process 300 may include extracting, by a contour extracting module (for example, the contour extracting module 204), a plurality of contours corresponding to the plurality of elements in the document image using a contour extraction technique, at step 314. It may be noted that each of the plurality of contours may include a set of points (or pixels) that defines a corresponding element. Extracting the plurality of contours may include identifying a location of each of the plurality of contours. The location corresponds to position coordinates of each of the corresponding plurality of elements.

Further, the process 300 may include eliminating, by a contour filtering module (for example, the contour filtering module 206), a first set of false positive selection elements from the plurality of contours using one or more contour filters to obtain a plurality of filtered contours, at step 316. In other words, the plurality of filtered contours may correspond to a plurality of localized selection elements. By way of an example, the one or more contour filters may include, but may not be limited to, at least one of a polygonal curve count filter, a bounding box aspect ratio filter, a bounding box size filter, a bounding box area filter, a bounding box orientation filter, a nearest neighbour bounding box elimination filter, an inner contour removal filter, and a dynamic area filter. The step 316 of the process 300 may include sequentially applying, by the contour filtering module, the one or more contour filters to each of the plurality of elements, at step 318. Further, the step 316 of the process 300 may include identifying, by the contour filtering module, the first set of false positive selection elements from the plurality of elements based on a predefined threshold of each of the one or more contour filters to eliminate the first set of false positive selection elements, at step 320.

Further, the process 300 may include eliminating, by a CNN module (for example, the CNN module 208) via a CNN model, a second set of false positive selection elements from the plurality of filtered contours, prior to determining the plurality of selection elements, at step 322. Further, the process 300 may include determining, by the CNN module via the CNN model, the plurality of selection elements and a selection state corresponding to each of the plurality of selection elements, from the plurality of filtered contours. The selection state may correspond to one of selected or unselected, at step 324.

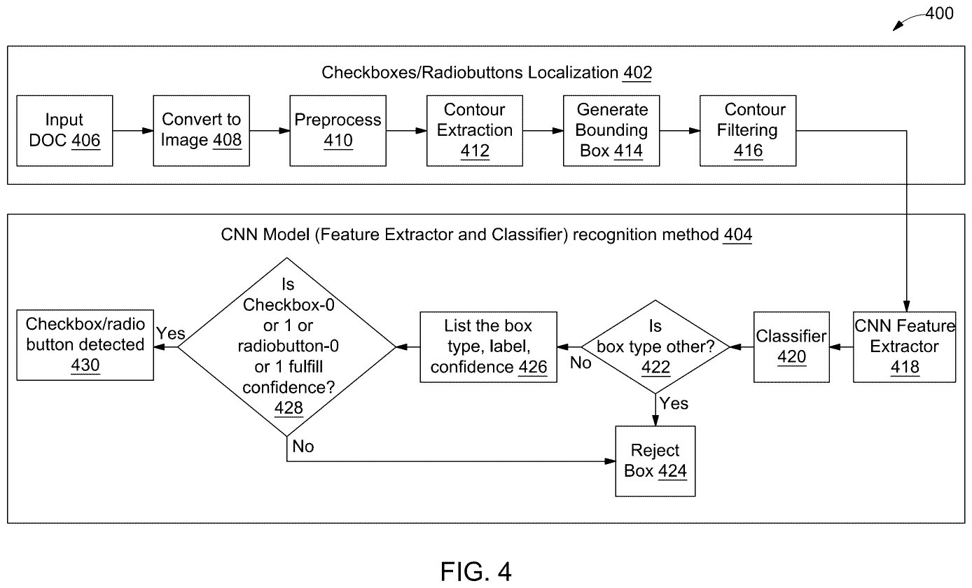

Referring now to FIG. 4, a detailed exemplary control logic 400 for automatic detection of selection elements in digitized documents is illustrated, in accordance with some embodiments. FIG. 4 is explained in conjunction with FIGS. 1, 2, and 3. The control logic 400 may be implemented by the computing device 102 of the system 100. The control logic 400 may be executed in two stages. A first stage 402 may correspond to localization of selection elements (i.e., checkboxes and radio buttons). A second stage 404 may correspond to CNN model-based selection elements recognition. To explain generally, the localization of selection elements may include application of one or more contour filters (i.e., computer vision-based contouring and heuristic filters) to detect exact locations of the plurality of selection elements. The CNN model recognition method may identify, via a deep learning model (i.e., the CNN model), whether the selection states of the plurality of selection elements corresponds to selected or unselected. Additionally, the CNN model may reduce false positive selection elements from the plurality of selection elements.

More specifically, the stage 402 of the control logic 400 may include receiving, by the pre-processing module 202, an input document 406. The input document 406 may be in a document format (e.g., PDF, DOC, etc.) and may include one or more pages. Further, the control logic 400 may include converting, by the preprocessing module 202, the input document 406 into a document image (for example, the document image 212), at step 408. The document image may be in an image format (e.g., PNG, JPG, TIFF, etc.).

Further, the control logic 400 may include pre-processing, by the pre-processing module 202, the document image, at step 410. As will be appreciated, pre-processing is performed to reduce the noise and to improve the overall quality of an input image. Consequently, for input images with varying quality, applying the same pre-processing steps may not be optimal. Therefore, the step 410 may include quality assessment of the document image and a customized pre-processing of the document image based on the quality assessment. The quality assessment may include determining a set of quality parameters for the document image. The set of quality parameters may include, but may not be limited to, DPI, blur, sharpness, contrast, colour, resolution, and noise.

Further, the pre-processing module 202 may input the calculated set of quality parameters to the quality assessment model. In an embodiment, the quality assessment model may be a random forest machine learning model. Further, the quality assessment model may classify the document image into one of a set of quality categories (e.g., a good quality image, a medium quality image, or a bad quality image). The quality assessment model may be trained on a large image dataset to classify the document image into the set of quality categories.

The customized pre-processing may include applying one or more pre-processing techniques based on the quality category of the document image. By way of an example, the one or more preprocessing techniques may be selected from a group including, but not limited to, grayscale conversion, noise reduction and smoothening, skew detection and correction, morphological open operation, and applied thresholding. The pre-processing module 202 may select the one or more pre-processing techniques from the group based on the quality category. In an embodiment, the pre-processing module 202 may determine a sequential order in which the one or more pre-processing steps may be applied to the document image. In an embodiment, the pre-processing module 202 may also select a level or degree of each of the one or more pre-processing techniques based on the quality category. For example, a bad quality image may require a stronger level of pre-processing compared to a good quality image.

For grayscale conversion, the pre-processing module 202 may convert the document image (colored) to a grayscale image. The pre-processing module 202 may convert a color space of the document image from Red Green Blue (RGB) to grayscale. using the following exemplary code.
gray=cv2.cvtColor(image, cv2.COLOR_BGR2GRAY)

For noise reduction and smoothening, the pre-processing module 202 may denoise an input image. The “input image” as referred to in conjunction with the pre-processing steps described hereon may imply an image provided as an input to a given pre-processing step. Thus, the “input image” may be the document image (when received by the first pre-processing step in the series of the one or more pre-processing steps) or may be the document image already subjected to at least one of the series of pre-processing steps. Denoising may suppress noise without losing features of the input image. Denoising may be done by an opening morphological operation and a closing morphological operation. The opening morphological operation may reduce the noise, and the closing morphological operation may fill small holes in foreground objects, or may fill small black points on the objects. Further, the pre-processing module 202 may smoothen the input image through different low pass filtering for noise reduction and blurring operations. The low pass filtering may remove high spatial frequency noise from the input image. Further, the pre-processing module 202 may equalize a contrast of the gray scale image. For example, “cv2.equalizeHist( )” function may be used to normalize the brightness and increase the contrast. The contrast enhancement may improve the quality of the gray scale image by increasing the illumination difference between foreground and backgrounds of the gray scale image.

For skew detection and correction, the pre-processing module 202 may detect a skew (i.e., tilt) in the input image and may also correct the skew detected in the input image. To detect the skew, the pre-processing module 202 may detect lines in the input image using a Hough transform. The Hough transform is a technique to locate shapes in an image. Further, the pre-processing module 202 may find angles of the lines relative to the x-axis. Further, the pre-processing module 202 may determine an exact skew angle based on the angles of the lines. Finally, the pre-processing module 202 may obtain a de-skewed image after rotating the input image by the exact skew angle.

For morphological open operation, the pre-processing module 202 may apply a morphological open operation to the input image. The morphological open operation may remove elements that may not fit a predefined structural element (for example, a rectangle or a circle) of certain dimension (for example, the rectangle of dimension (3,1)). The morphological open operation may include successive application of dilation and erosion on the input image. Two types of structural elements may be applied along with the respective morphological open operation for horizontal and vertical components in the input image. The outputs thus obtained from the horizontal and the vertical morphological open operations may then be combined together to reduce small and noise information and get bigger structural elements from the input image. By way of an example, a code below may be applied to obtain the combined output.

#Horizontal Open
kernel = cv2.getStructuringElement(cv2.MORPH_RECT, (3,1))
horizontal = cv2.morphologyEx(gray, cv2.MORPH_OPEN, kernel, iterations=1)
#Vertical Open
kernel = cv2.getStructuringElement(cv2.MORPH_RECT, (1,3))
vertical = cv2.morphologyEx(gray, cv2.MORPH_OPEN, kernel, iterations=1)
#Add Horizontal Open and Vertical Open results
gray = cv2.addWeighted(vertical, 0.5, horizontal, 0.5, 0.0)

For applied thresholding, the pre-processing module 202 may apply binarization to the input image. Binarization may convert the input image into a binary image. For binarization, pixels with an intensity level above a threshold value may be assigned white colour and the rest of the input image may be assigned black colour. By way of an example, a code below may be used to apply binarization.
ret,img=cv2.threshold(gray,127,255,cv2.THRESH_BINARY+cv2.THRESH_OTSU)

Upon completion of the step 410, a preprocessed image may be obtained with the relevant elements highlighted and any potential background noise removed. Further, the control logic 400 may include contour extraction, at step 412. The contour extracting module 204 may extract a plurality of contours from the pre-processed image corresponding to the plurality of elements using a contour extraction technique to obtain a first marked image. It should be noted that the contours may be a set of points (or boundary pixels) that may define an entity. By way of an example, a contour extraction code below may be applied to the pre-processed image to extract the contours.

contours,hierarchy = cv2.findContours(img, cv2.RETR_TREE,
cv2.CHAIN_APPROX_SIMPLE)

The contour extraction technique (i.e., the findContours method) may extract the plurality of contours and hierarchy relations of the plurality of contours. Outer contours may be skipped as the checkbox or the radio button is mostly small. The plurality of selection elements may be detected in the first marked image. However, the first marked image may still include unwanted elements (i.e., false positive selection elements). Further, the control logic 400 may include generating bounding boxes for each of the plurality of contours in the first marked image, at step 414. Further, the control logic 400 may include contour filtering, at step 416. The contour filtering module 206 may sequentially apply one or more contour filters to the first marked image to remove the unwanted elements to obtain a second marked image. By way of an example, the one or more contour filters may include at least one of a polygonal curve count filter, a bounding box aspect ratio filter, a bounding box size filter, a bounding box area filter, a bounding box orientation filter, a nearest neighbour bounding box elimination filter, an inner contour removal filter, and a dynamic area filter.

Through the polygonal curve count filter, the contour filtering module 206 may eliminate the polygon with less than 4 polygonal curves. Further, through the bounding box aspect ratio filter, the contour filtering module 206 may compute a bounding box aspect ratio in the first marked image. An aspect ratio is a proportional relationship between a width of the first marked image and the height of the first marked image. It should be noted that bounding boxes for the checkboxes or radio buttons contours may have width and height having certain aspect ratio range (for example, about 1.6). Therefore, the aspect ratio of the checkboxes or the radio buttons may be computed based on the greater value of either width or height of the checkboxes or radio buttons. If the width is greater than the height, then the aspect ratio may be width/height. On the other hand, if the height is greater than the width, the aspect ratio may be height/width. Thus, many unwanted contours bounding boxes may be removed from the first marked image.

Through the bounding box size filter, the contour filtering module 206 may apply bounding box size (dimension) filter to the first marked image. The bounding boxes not satisfying a threshold length value and a threshold width value may be eliminated. For example, the bounding boxes having length greater than 10 and less than 90 may be eliminated. Thus, many unwanted bounding boxes may be eliminated from the first marked image. It should be noted, however, that if the checkboxes or the radio buttons are smaller than the threshold values, such checkboxes or the radio buttons may be eliminated. Thus, to prevent such a scenario, the threshold length value and the threshold width value may be updatable in a configuration file.

Through the bounding box area filter, the contour filtering module 206 may remove the contours of the text characters in the first marked image. In most cases, the bounding box area of a text character is smaller than the bounding box area of checkboxes or radio buttons. Also, due to variation of width and height some unwanted bounding boxes may not be filtered by the bounding box size filter. For example, the counter filtering module 206 may remove the bounding boxes having threshold area above 5000 or threshold area below 180 from the first marked image. The threshold area may be updatable in a configuration file.

Through the bounding box orientation filter, the counter filtering module 206 may remove some additional unwanted boundary boxes (such as some text characters, handwritten letters, blobs, and other images). The bounding box orientation filter may only be applied for rectangular shaped bounding boxes, as circle, oval, or ellipse shaped bounding boxes will be considered as a radio button. A bounding box threshold orientation value may be defined and the bounding boxes with the orientation beyond the defined threshold orientation value may be eliminated. For example, the contour filtering module 206 may eliminate the checkboxes having orientations between 10 and 80 or −80 and −10. To calculate the orientation of the bounding box, the bounding box of the contour (i.e., a first rectangle) and a minimum area rectangle (i.e., a second rectangle) are obtained. The first rectangle is a convex contour or rectangular contour line. It tries a straight rectangular shape first. With the outer contour line of the element, a rectangle is drawn around the element. The straight rectangle is not the minimum among other possible bounding boxes. The function cv2.boundingRect( ) returns the 4 points of the bounding box. The second rectangle is obtained by extracting a rectangle with the minimum area using the function cv2.minAreaRect( ) which finds a rotated rectangle enclosing the input 2D point set. The orientation is calculated as a difference between the orientations of the first rectangle and the second rectangle.

Through the nearest neighbour bounding box elimination filter, the contour filtering module 206 may eliminate nearest neighbor bounding boxes. It should be noted that the space between two characters may be less than between two checkboxes or radio buttons. Therefore, the contour filtering module 206 may apply nearest bounding box concept applying hierarchy structure of contouring process. The cv2.findContours( ) function may be used to detect elements in the first marked image and may also provide the hierarchical relation between the contours. It should be noted that the contours in an image may have relationship with each other and relation of one contour to another contour may be specified (i.e., whether the contour is the child of some other contour, or the contour is the parent or sibling (next, previous), or the contours are unrelated, etc.) The contour filtering module 206 may apply nearest neighbor (sibling-next, previous) concept to check the nearest elements with a predefined threshold value. If the bounding boxes are close, then the contour filtering module 206 may eliminate such bounding boxes. This may reduce the bounding boxes of false positive selection elements.

Through the inner contour removal filter, the contour filtering module 206 may remove inside contours from the checkboxes or radio buttons and may keep only the outer contour. The inner contour may may be removed by box intersect logic. The box intersect logic may be as follows

```
isRectangleInside(rectangle1, rectangle2):
  isInside = False
  start1X,start1Y,end1X,end1Y = rectangle1
  start2X,start2Y,end2X,end2Y = rectangle2
  if start1X <= start2X and start 1Y <= start2Y and end2X <= end2Y <=
end1Y:
    flag = true
```

The contour filtering module 206 may apply the above condition to eliminate all inner contour bounding boxes from the first marked image.

Through the dynamic area filter, the contour filtering module 206 may apply a filter dynamic area threshold value. It should be noted that unwanted bounding boxes remaining in the first marked image may be comparatively smaller than the checkboxes or the radio buttons. By way of an example, different document images have 1 to 4 different sizes of checkboxes or radio buttons. The contour filtering module 206 may sort all remaining filter bounding box area value and may create different groups. All closure area number may be included in a same group. Once the groups are performed, the contour filtering module 206 may calculate the average value of each group and then create a list of all the elements. Further, the list may be sorted into four groups. Further, the contour filtering module 206 may calculate the average of the first group and may compare the average value with the threshold value. Based on the comparison the contour filtering module 206 may eliminate the unwanted bounding boxes (the bounding box whose area is less than the computed threshold value). Further, after eliminating the unwanted contour bounding box, the contour filtering module 206 may obtain a filtered document image (i.e., a second marked image). Finally, the contour filtering module 206 may send the filtered document image to a CNN feature extractor 418 to initiate the stage 404.

After all the filters are applied to obtain the filtered document image, the filtered document image may still include unwanted boxes. The stage 404 of the control logic 400 may include extracting, by the CNN module 208 via the CNN feature extractor 418, the a set of features (or a feature map) from the second marked image. Further, the CNN feature extractor 418 may send the second marked image and the set of features to a classifier 420. The classifier 420 may determine a box type (i.e., checkbox, radio button, or other) corresponding to the bounding box, a label assigned to the element (i.e., checkbox, radio button, or other), a confidence score of the determined label, a selection state of the checkbox and radio button box type elements, and a confidence score of the determined selection state.

Further, at step 422 of the control logic 400, a check may be performed to determine whether the box type of the bounding box is other than a checkbox or a radio button. If the box type is determined as other than the checkbox or the radio button, the control logic 400 may proceed to step 424 (“Yes” path). At step 424, the control logic 400 may include rejecting (or eliminating) the bounding box. If the box type is determined as not other than the checkbox or the radio button, the control logic 400 may proceed to step 426 (“No” path). The control logic 400 may include listing, by the CNN module 208, the box type of the bounding box, label of the bounding box, and confidence of the classifier 420

Further, at step 428 of the control logic 400, a check may be performed to determine whether the confidence score of the determined selection state (i.e., selected or unselected) above a predefined confidence score. If the confidence score of the determined selection state is less than the predefined confidence score, the control logic 400 may return to the step 424 (“No” path). In such a scenario, the bounding box may be eliminated. If the confidence score of the determined selection state is less than the predefined confidence score, the control logic 400 may proceed to step 430 (“Yes” path). The step 430 of the control logic 400 may include detecting, by the CNN module 208, the checkboxes or radio buttons.

To detect the if the checkboxes and the radio buttons are checked or not, a classification model is created. The classification is the process of labeling images according to predefined categories. The classification may be based on supervised learning. The classification model may be fed a set of images within a specific category. Based on the set of images fed, the classification model algorithm may learn the class to which the images fed belong. Therefore, the classification model may predict the correct class of future image inputs and may even measure the accuracy of the predictions.

To automatically detect the checkbox, radio buttons, and text classes a CNN-based classification approach may be used. The CNN module 208 may extract the features from the second marked image using the CNN feature extractor 418. During the feature extraction, various strategies may be applied to extract the desired features from the second marked image. The strategies may include convolution operation, max pooling, flattening, and fully connected layer.

A deep neural network CNN model may be used for recognition of checkboxes or radio buttons. The CNN is a deep learning model used in computer vision application for image classification. The CNN may include five layers. The first layer may be a convolution layer. The convolution layer may perform a convolution operation to create several smaller picture windows to go over the data. The operations perform at convolution layer may be still linear/matrix multiplications. The operations may go through an activation function at the output, which is usually a non-linear operation.

The second layer may be ReLU layer. The Relu layer may bring non-linearity to the network and may convert all the pixels of the image to zero. The output may be a rectified feature map. The third layer may be Max Pooling Layer. Pooling is a down-sampling operation. Pooling may reduce the dimensionality of the feature map. The pooling layer may reduce the number of operations required for all the following layers but still may pass the valid information from the previous layers. A max pooling, a pool size of 2×2 may be used to reduce the number of features by max-pooling.

The fourth layer may be a fully connected input layer. The fully connected input layer may flatten the output of the previous layer and may turn the output into a single vector that may be input for the fifth layer. The fifth layer may be a fully connected output layer. The fully connected output layer may recognize and classify the objects in the image and may further give the final probabilities for each label.

The CNN model may include three convolution layers and two dense layers for classification. The CNN may operate in three stages. The first stage may be a convolution stage. The convolution stage may scan a few pixels at a time of the image and a feature map. The second stage may be activation functions attached to each neuron in the network. The second stage may also determine whether the activation function should be activated or not. The activation function may normalize the output of each neuron. The third stage may be pooling. The pooling may reduce the dimensionality of each feature and may also maintain the most important information of the feature.

The first layer parameter may take 2-Dimensional (2D) convolutional layers with the input image. The 2D convolutional layers may be seen as 2D matrices with following parameters: 32 of neural nodes in the layer, Kernel size=3×3—this may be the area in square pixels the model will use to “scan” the image, and input shape (40,40) pixel size of the images with the image depth 3.

The Activation function (ReLu) may be used after each convolutional layer. The Activation function (ReLu) may help the network to converge very quickly. Further, max pooling may be used to reduce the spatial dimensions of the output volume and may also help in efficient computation. A dataset may include images of fixed size of 40×40×3 RGB image which may pass through the first convolutional layers with 32 filters having size 3×3 and 2×2 pooling.

model.add(Conv2D(filters = 32, kernel_size = (3, 3), input_shape=(40, 40, 3)))
model.add(Activation(‘relu’))
model.add(MaxPooling2D(pool_size=(2, 2)))

The second layer of convolution may take 2D convolution layers, 32 of neural nodes in the layer, kernel size=3×3. The kernel size=3×3 may be the area in square pixels the model will use to “scan” the image. The Activation function (Relu) may be used after each convolution layer. Max pooling with size (2,2) may be used to reduce the spatial dimension of the output volume.

model.add(Conv2D(32, (3, 3)))
model.add(Activation(‘relu’))
model.add(MaxPooling2D(pool_size=(2, 2)))

The third layer of convolution and pooling may include 2D convolution layers, 64 of neural nodes in the layer, kernel size=3×3. The kernel size=3×3 may be the area in square pixels the model will use to “scan” the image. The Activation function (Relu) may be used after each convolution layer. Max pooling with size (2,2) may be used to reduce the spatial dimension of the output volume.

model.add(Conv2D(32, (3, 3)))
model.add(Activation(‘relu’))
model.add(MaxPooling2D(pool_size=(2, 2)))

The classification may be the process of labelling filtered localized bounding box into its output classes. The classification may be the top layer of the network. The classification may include flattening and two fully connected layer. The classification may collect the final convoluted feature along with final layer. The final layer may be the soft-max layer and may also return a column vector where each row points towards a class. The result of the output vector may represent the probability estimation of each class which is used as a confidence score of detection.

The flattening layer may take the output of the CNN Feature extractor and further turn the output to a format that mat be used by the first full-connected layer. model.add(Flatten( )). The first full-connected layer may take the inputs from the flattening layer. The output may be fed to fully connected layers with non-linearity to make sure these nodes interact well and account for all possible dependencies at the feature level and it can model more complex global patterns. The number of output nodes may be 64.
model.add(Dense(64))
model.add(Activation(‘relu’))

The second full-connected layer may regularize the network and may also avoid overfitting model. To regularize the network and may also avoid overfitting model a dropout may be applied with the probability of retaining the unit. The unit p=0.5. Add the final layer of type ‘Dense’, a full-connected neural layer which will generate the final prediction. Number of output nodes may be 5. The first output node may be checkbox-0. The second output node may be checkbox-1. The third output node may be radio button 0. The fourth output node may be radio button-1. The fifth output node may be text/numeric. The second full-connected layer may use softmax an activation function used for neural output layers. Softmax may take the Dense layer output and may convert the dense layer output to a meaningful probability for each of the bounding box, which may sum up to 1. The Softmax may then make a prediction label based on the highest probability.

model.add(Dropout(0.5))
model.add(Dense(units = 5))
model.add(Activation(‘softmax’))

Training and test data set preparation may include training data and test data. The training data cropped segments of the contour bounding box from the pre-processed image along with certain offset using several documents and the created five classes. The first class may be checkbox-0, the second class may be checkbox-1, the third class may be radio button-0, the fourth class may be radio button-1, and the fifth class may be text as like below data structure and manually collect 2500 for each set. Similarly, the test data may also include five classes. The five classes may be respectively stored in folders checkbox-0, checkbox-1, radio button-0, radio button-1, and text. The first class may be checkbox-0, the second class may be checkbox-1, the third class may be radio button-0, the fourth class may be radio button-1, and the fifth class may be text manually collect 500 for each set and may also store these classes in five different folders named as checkbox-0, checkbox-1, radio button-0, radio button-1, and text for each of the classes respectively. The data in the folders is feed for the CNN classification model.

Terms used in CNN usage may be epochs, batch_size, loss_function, optimizer. The epochs may be a number of iterations for neural network the training neural network. The batch_size may be a number of samples used for each epoch. The loss_function may be a function of errors. The function of errors may be expressed by the distance between fitted and actual values (if the target is continuous) or by the number of misclassified values (if the target is categorical). For example, Mean Square errors (in regression) or Categorical Cross-Entropy (in classification). The optimizer may be an algorithm that may adjust parameters in order to minimize the loss. Some examples of optimization functions may be available in Keras are Stochastic Gradient Descent (it minimizes the loss according to the gradient descent optimization, and for each iteration it randomly selects a training sample—that's why it's called stochastic), RMSProp (that differs from the previous since each parameter has an adapted learning rate) and Adam Optimizer (it is a RMSProp+momentum).

To create a neural network, initialize the network with the sequential class from keras model=Sequential( ) Further, add the first layer of convolution and pooling. To add the first layer of convolution and pooling,
model.add(Conv2D(filters=32, kernel_size=(3, 3), input_shape=(40, 40, 3)))
model.add(Activation(‘relu’))

### Arguments:

filters: Denotes the number of Feature detectors.
kernel_size: Denotes the shape of the feature detector. (3,3) denotes a 3×3 matrix.
input_shape: standardises the size of the input image.
activation: Activation function to break the linearity.

To add pooling layer,
model.add(MaxPooling2D(pool_size=(2, 2)))

### Arguments:

pool_size: the shape of the pooling window.

To add second layer of convolution and pooling, for convolution
model.add(Conv2D(32, (3, 3)))
model.add(Activation(‘relu’))
model.add(MaxPooling2D(pool_size=(2, 2)))

To add a third layer of convolution and pooling,
model.add(Conv2D(64, (3, 3)))
model.add(Activation(‘relu’))
model.add(MaxPooling2D(pool_size=(2, 2)))

To add flattening layer, model.add(Flaten( ))

In full-connected layer, to add the hidden layer
model.add(Dense(64))
model.add(Activation(‘relu’))

To add the output layer,
model.add(Dropout(0.5))
model.add(Dense(units=5))
model.add(Activation(‘softmax’))

### Arguments:

units: Number of nodes in the layer.
activation: the activation function in each node

Further, to compile the CNN
model.compile(loss=‘categorical_crossentropy’,optimizer=‘adam’,metrics=[‘accuracy’]).

The CNN model may be compiled with the following parameters. The optimizer may control the learning rate. The learning rate may define how fast optimal weights for the models may be calculated. For example, adam learning rate optimizer. The loss may define the loss function. The loss function may measure how far the model's prediction is from the ground truth, the correct digits for the images. For example, categorical_crossentropy’ may be loss function suitable for classification problems. Metrics may define how the model success may be evaluated. For example, the accuracy metric may calculate an accuracy score on the testing/validation set of images.

### Arguments:

Optimiser: The Optimiser used to reduce the cost calculated by cross-entropy.
Loss: the loss function used to calculate the error.
Metrics: the metrics used to represent the efficiency of the model

To generate image data,
from keras.preprocessing.image import ImageDataGenerator train_datagen=ImageDataGenerator(rescale=1./255, shear_range=0.1, zoom_range=0.2, horizontal_flip=True) #only rescaling test_datagen=ImageDataGenerator (rescale=1./255)

### Arguments:

rescale: Rescaling factor. Defaults to None. If None or 0, no rescaling is applied, otherwise we multiply the data by the value provided
shear_range: Shear Intensity. Shear angle in a counter-clockwise direction in degrees.
zoom_range: Range for random zooming of the image

To fit images to the CNN, the following function may let the classifier identify the labels from the name of the directories the image lies in

```
  training_set = train_datagen.flow_from_directory(‘dataset/training_set’,
    target_size= (40,40),
    batch_size = 16,
    class_mode = ‘softmax)
test_set = test_datagen.flow_from_directory(‘dataset/test_set’,
      target_size = (40, 40),
      batch_size = 16,
      class_mode = ‘softmax)
```

Arguments:
directory: Location of the training_set or test_set
target_size: The dimensions to which all images found will be resized.Same as input size.
Batch_size: Size of the batches of data (default: 16).
Class_mode: Determines the type of label arrays that are returned.One of “categorical”, “binary”, “sparse”, “input”, or None

To train and evaluate the model,

```
model.fit_generator(training_set,
  samples_per_epoch = 12500/16,
  nb_epoch = 200,
  validation_data = test_set,
  nb_val_samples = 500)
```

### Arguments:

generator: A generator sequence used to train the neural network (Training_set).
Samples_per_epoch:Total number of steps (batches of samples) to yield from genera-tor before declaring one epoch finished and starting the next epoch. It should typically be equal to the number of samples of your dataset divided by the batch size.
Nb_epoch: Total number of epochs. One complete cycle of predictions of a neural net-work is called an epoch.
Validation_data: A generator sequence used to test and evaluate the predictions of the neural network (Test_set).
Nb_val_samples: Total number of steps (batches of samples) to yield from valida-tion_data generator before stopping at the end of every epoch.

The above function may train the neural network using the training set and may evaluate the performance on the test set. The function may return two metrics for each epoch “acc” and “val_acc”. The two metrics may be the accuracy of predictions obtained in the training set and accuracy attained in the test set respectively.

To train the CNN,

Found 12500 images belonging to 5 classes.

Found 2500 images belonging to 5 classes.

```
    C:\objectdetectedtype.py:117: UserWarning: ‘Model.fit_generator‘ is
  deprecated and will be removed in a future version. Please use ‘Mod-el.fit‘,
  which supports generators.
      model.fit_generator(
    Epoch 1/200
781/781 [==============================] - 144s 183ms/step - loss:
0.2551 - accura-cy: 0.9079 - val_loss: 0.0574 - val_accuracy: 0.9828
Epoch 2/200
781/781 [==============================] - 16s 20ms/step - loss: 0.0703
- accuracy: 0.9818 - val_loss: 0.0635 - val_accuracy: 0.9812
Epoch 3/200
781/781 [==============================] - 15s 20ms/step - loss: 0.0536
- accuracy: 0.9870 - val_loss: 0.0613 - val_accuracy: 0.9840
Epoch 4/200
781/781 [==============================] - 16s 21ms/step - loss: 0.0472
- accuracy: 0.9875 - val_loss: 0.0456 - val_accuracy: 0.9868
Epoch 5/200
781/781 [==============================] - 16s 21ms/step - loss: 0.0427
- accuracy: 0.9883 - val_loss: 0.0349 - val_accuracy: 0.9908
Epoch 6/200
781/781 [==============================] - 16s 20ms/step - loss: 0.0376
- accuracy: 0.9900 - val_loss: 0.0447 - val_accuracy: 0.9868
Epoch 7/200
781/781 [==============================] - 16s 21ms/step - loss: 0.0354
- accuracy: 0.9911 - val_loss: 0.0479 - val_accuracy: 0.9896
Epoch 8/200
781/781 [==============================] - 16s 21ms/step - loss: 0.0356
- accuracy: 0.9906 - val_loss: 0.0480 - val_accuracy: 0.9860
Epoch 9/200
781/781 [==============================] - 16s 20ms/step - loss: 0.0285
- accuracy: 0.9926 - val_loss: 0.0419 - val_accuracy: 0.9856
Epoch 10/200
781/781 [==============================] - 16s 21ms/step - loss: 0.0277
- accuracy: 0.9921 - val_loss: 0.0547 - val_accuracy: 0.9864
Epoch 11/200
781/781 [==============================] - 16s 21ms/step - loss: 0.0302
- accuracy: 0.9925 - val_loss: 0.0347 - val_accuracy: 0.9912
Epoch 12/200
781/781 [==============================] - 16s 20ms/step - loss: 0.0278
- accuracy: 0.9918 - val_loss: 0.0444 - val_accuracy: 0.9836
Epoch 13/200
781/781 [==============================] - 16s 21ms/step - loss: 0.0225
- accuracy: 0.9938 - val_loss: 0.0434 - val_accuracy: 0.9884
Epoch 14/200
781/781 [==============================] - 16s 21ms/step - loss: 0.0261
- accuracy: 0.9927 - val_loss: 0.0424 - val_accuracy: 0.9908
Epoch 15/200
781/781 [==============================] - 16s 21ms/step - loss: 0.0236
- accuracy: 0.9939 - val_loss: 0.0390 - val_accuracy: 0.9920
Epoch 16/200
781/781 [==============================] - 16s 21ms/step - loss: 0.0246
- accuracy: 0.9930 - val_loss: 0.0530 - val_accuracy: 0.9840
Epoch 17/200
781/781 [==============================] - 16s 21ms/step - loss: 0.0220
- accuracy: 0.9943 - val_loss: 0.0355 - val_accuracy: 0.9904
Epoch 18/200
781/781 [==============================] - 16s 20ms/step - loss: 0.0224
- accuracy: 0.9929 - val_loss: 0.0361 - val_accuracy: 0.9948
Epoch 19/200
781/781 [==============================] - 16s 21ms/step - loss: 0.0191
- accuracy: 0.9948 - val_loss: 0.0419 - val_accuracy: 0.9932
Epoch 20/200
781/781 [==============================] - 16s 21ms/step - loss: 0.0202
- accuracy: 0.9942 - val_loss: 0.0602 - val_accuracy: 0.9916
Epoch 21/200
781/781 [==============================] - 16s 21ms/step - loss: 0.0214
- accuracy: 0.9941 - val_loss: 0.0301 - val_accuracy: 0.9932
Epoch 22/200
781/781 [==============================] - 17s 22ms/step - loss: 0.0138
- accuracy: 0.9958 - val_loss: 0.0469 - val_accuracy: 0.9924
Epoch 23/200
781/781 [==============================] - 21s 26ms/step - loss: 0.0185
- accuracy: 0.9947 - val_loss: 0.0435 - val_accuracy: 0.9916
Epoch 24/200
781/781 [==============================] - 17s 21ms/step - loss: 0.0158
- accuracy: 0.9953 - val_loss: 0.0876 - val_accuracy: 0.9872
Epoch 25/200
781/781 [==============================] - 17s 21ms/step - loss: 0.0187
- accuracy: 0.9944 - val_loss: 0.0526 - val_accuracy: 0.9912
Epoch 26/200
781/781 [==============================] - 17s 22ms/step - loss: 0.0200
- accuracy: 0.9947 - val_loss: 0.0509 - val_accuracy: 0.9912
Epoch 27/200
781/781 [==============================] - 17s 21ms/step - loss: 0.0174
- accuracy: 0.9954 - val_loss: 0.0905 - val_accuracy: 0.9860
Epoch 28/200
781/781 [==============================] - 17s 22ms/step - loss: 0.0175
- accuracy: 0.9953 - val_loss: 0.0379 - val_accuracy: 0.9928
Epoch 29/200
781/781 [==============================] - 17s 22ms/step - loss: 0.0188
- accuracy: 0.9956 - val_loss: 0.0565 - val_accuracy: 0.9892
```

Tried several combinations of hyperparameters in order to achieve the highest accuracy possible.

```
#Model predictions
loadModel = load_model(self.modelPath)
preds = model.predict_classes(x)
prob = model.predict_proba(x)
if preds[0] == 0:
  boxType = ‘checkbox-0’
  probability = prob.item(0)
elif preds[0] == 1:
  boxType = ‘checkbox-1’
  probability = prob.item(1)
elif preds[0] == 2:
  boxType = ‘radiobutton-0’
  probability = prob.item(2)
elif preds[0] == 3:
  boxType = ‘radiobutton-1’
  probability = prob.item(3)
else:
  boxType = ‘text’
  probability = prob.item(4)
```

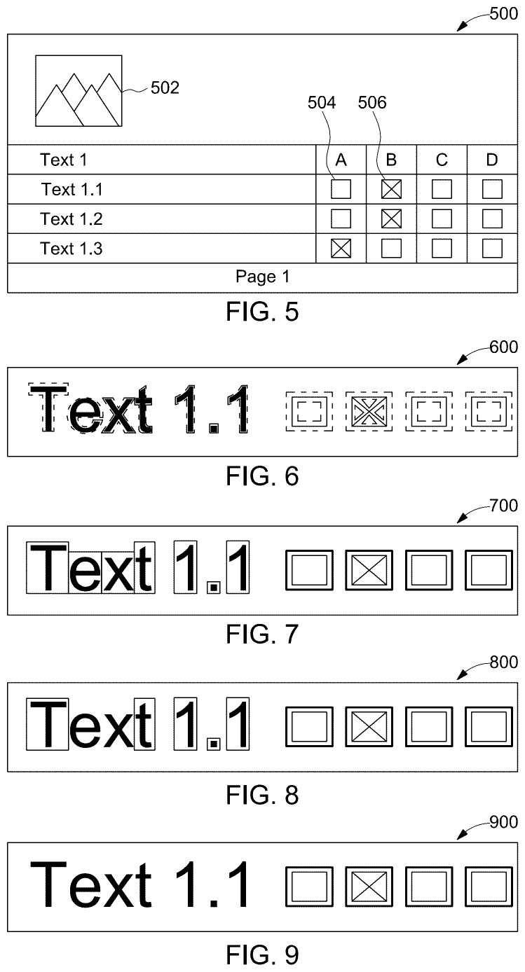

Referring now to FIG. 5, an exemplary document image 500 is illustrated, in accordance with an embodiment. FIG. 5 is explained in conjunction with FIGS. 1, 2, 3, and 4. The document image 500 may include a logo 502, a “text 1”, a “text 1.1”, a “text 1.2”, and a “text 1.3”. The document image may further include a section for a plurality of checkboxes (such as a checkbox 504 and a checkbox 506). Once the document image 500 is received, the pre-processing module 202 may pre-process the document image 500 using one or more pre-processing techniques to obtain a pre-processed image. The pre-processing techniques have already been explained in greater detail in conjunction with FIGS. 2 and 4.

Referring now to FIG. 6, contour extraction in an exemplary portion 600 of a document image, in accordance with an embodiment. FIG. 6 is explained in conjunction with FIGS. 1, 2, 3, 4, and 5. Once the document image 500 is pre-processed, the contour extracting module 204 may extract a plurality of contours corresponding to the plurality of elements in the document image using a contour extraction technique. Each of the plurality of contours may include a set of points that may define an element. Each of the elements in the contour extracted image may include an outline indicative of the extracted contour. For elements such as the selection elements, the contour may be identified for an outer border and an inner border. For text characters, the contour for at least the outer border may be identified. For some text characters (such as “o” “0”, “a”, “b”, “d”, “e”, “0”, “8”, “6”, etc.), the contour for the inner border may also be identified. By way of an example, upon contour extraction, the portion 600 (obtained after contour extraction of the document image 500) may include contours for each character of the text “text 1.1”, and the checkboxes 504 and 506.

Referring now to FIG. 7, element detection through bounding boxes in an exemplary portion 700 of a document image is illustrated, in accordance with an embodiment. FIG. 7 is explained in conjunction with FIGS. 1, 2, 3, 4, 5, and 6. Once the plurality of contours is extracted in the portion 600, the contour filtering module 206 may generate bounding boxes for the plurality of contours of the plurality of elements in the portion 600 to obtain the portion 700. The contour filtering module 206 may apply bounding boxes to the text characters (for example, each character of the text “text 1.1”) and a plurality of selection elements (for example, the checkbox 504 and the checkbox 506).

Referring now to FIG. 8, contour filtering in an exemplary portion 800 of a document image is illustrated, in accordance with an embodiment. After generating the bounding boxes, the contour filtering module 206 may apply one or more contour filters to eliminate a first set of false positives from the portion 700 to obtain the portion 800. Through the one or more contour filters, some of the unwanted bounding boxes may be eliminated. By way of an example, in the portion 800, bounding boxes corresponding to some text characters (such as the characters “e” and “x”) have been eliminated in the text “Text 1.1”. The bounding boxes corresponding to the plurality of selection elements (such as the checkbox 504 and the checkbox 506) have not been eliminated. Thus, only false positive bounding boxes have been eliminated.

Referring now to FIG. 9, detection of selection elements in an exemplary portion 900 of a document image is illustrated, in accordance with an embodiment. Upon eliminating the bounding boxes corresponding to the first set of false positive selection elements, the portion 800 still includes some unwanted bounding boxes (such as the text characters “T”, numbers “1” and a period sign “.”). The CNN module 208, via the CNN model, may eliminate a second set of unwanted bounding boxes from the portion 800 to obtain the portion 900. By way of an example, in the portion 900, the bounding boxes corresponding to the text characters “T”, numbers “1” and a period sign “.” have been eliminated. The bounding boxes corresponding to the plurality of selection elements (such as the checkbox 504 and the checkbox 506) are not eliminated. Thus, the plurality of selection elements may be identified. Additionally, the CNN module 208, via the CNN model, may identify the selection state of the selection elements. Thus, in the portion 900, the selection state of the checkbox 504 may be identified as unselected and the selection state of the checkbox 506 may be identified as selected.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

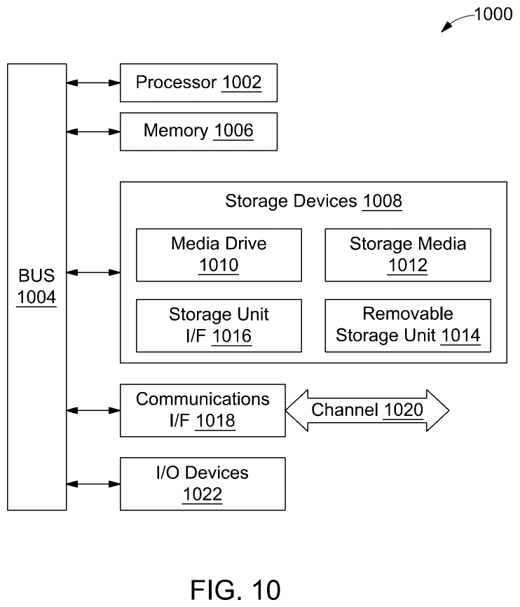

The disclosed methods and systems may be implemented on a conventional or a general-purpose computer system, such as a personal computer (PC) or server computer. Referring now to FIG. 10, an exemplary computing system 1000 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 1000 may represent, for example, a user device such as a desktop, a laptop, a mobile phone, personal entertainment device, DVR, and so on, or any other type of special or general-purpose computing device as may be desirable or appropriate for a given application or environment. The computing system 1000 may include one or more processors, such as a processor 1002 that may be implemented using a general or special purpose processing engine such as, for example, a microprocessor, microcontroller or other control logic. In this example, the processor 1002 is connected to a bus 1004 or other communication medium. In some embodiments, the processor 1002 may be an Artificial Intelligence (AI) processor, which may be implemented as a Tensor Processing Unit (TPU), or a graphical processor unit, or a custom programmable solution Field-Programmable Gate Array (FPGA).

The computing system 1000 may also include a memory 1006 (main memory), for example, Random Access Memory (RAM) or other dynamic memory, for storing information and instructions to be executed by the processor 1002. The memory 1006 also may be used for storing temporary variables or other intermediate information during execution of instructions to be executed by the processor 1002. The computing system 1000 may likewise include a read only memory (“ROM”) or other static storage device coupled to bus 1004 for storing static information and instructions for the processor 1002.

The computing system 1000 may also include a storage devices 1008, which may include, for example, a media drive 1010 and a removable storage interface. The media drive 1010 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 1012 may include, for example, a hard disk, magnetic tape, flash drive, or other fixed or removable medium that is read by and written to by the media drive 1010. As these examples illustrate, the storage media 1012 may include a computer-readable storage medium having stored therein particular computer software or data.

In alternative embodiments, the storage devices 1008 may include other similar instrumentalities for allowing computer programs or other instructions or data to be loaded into the computing system 1000. Such instrumentalities may include, for example, a removable storage unit 1014 and a storage unit interface 1016, such as a program cartridge and cartridge interface, a removable memory (for example, a flash memory or other removable memory module) and memory slot, and other removable storage units and interfaces that allow software and data to be transferred from the removable storage unit 1014 to the computing system 1000.

The computing system 1000 may also include a communications interface 1018. The communications interface 1018 may be used to allow software and data to be transferred between the computing system 1000 and external devices. Examples of the communications interface 1018 may include a network interface (such as an Ethernet or other NIC card), a communications port (such as for example, a USB port, a micro USB port), Near field Communication (NFC), etc. Software and data transferred via the communications interface 1018 are in the form of signals which may be electronic, electromagnetic, optical, or other signals capable of being received by the communications interface 1018. These signals are provided to the communications interface 1018 via a channel 1020. The channel 1020 may carry signals and may be implemented using a wireless medium, wire or cable, fiber optics, or other communications medium. Some examples of the channel 1020 may include a phone line, a cellular phone link, an RF link, a Bluetooth link, a network interface, a local or wide area network, and other communications channels.

The computing system 1000 may further include Input/Output (I/O) devices 1022. Examples may include, but are not limited to a display, keypad, microphone, audio speakers, vibrating motor, LED lights, etc. The I/O devices 1022 may receive input from a user and also display an output of the computation performed by the processor 1002. In this document, the terms “computer program product” and “computer-readable medium” may be used generally to refer to media such as, for example, the memory 1006, the storage devices 1008, the removable storage unit 1014, or signal(s) on the channel 1020. These and other forms of computer-readable media may be involved in providing one or more sequences of one or more instructions to the processor 1002 for execution. Such instructions, generally referred to as “computer program code” (which may be grouped in the form of computer programs or other groupings), when executed, enable the computing system 1000 to perform features or functions of embodiments of the present invention.

In an embodiment where the elements are implemented using software, the software may be stored in a computer-readable medium and loaded into the computing system 1000 using, for example, the removable storage unit 1014, the media drive 1010 or the communications interface 1018. The control logic (in this example, software instructions or computer program code), when executed by the processor 1002, causes the processor 1002 to perform the functions of the invention as described herein.

Thus, the disclosed method and system try to overcome the technical problem of automatic detection of selection elements in digitized documents. The disclosed method and system may receive a document image comprising a plurality of elements. The plurality of elements may include a plurality of selection elements. Each of the plurality of selection elements is one of a checkbox or a radio button. Further, the disclosed method and system may extract a plurality of contours corresponding to the plurality of elements in the document image using a contour extraction technique. Further, the disclosed method and system may eliminate a first set of false positive selection elements from the plurality of contours using one or more contour filters to obtain a plurality of filtered contours. Further, the disclosed method and system may determine, via a Convolution Neural Network (CNN) model, the plurality of selection elements and a selection state corresponding to each of the plurality of selection elements, from the plurality of filtered contours. The selection state corresponds to one of selected or unselected.

As will be appreciated by those skilled in the art, the techniques described in the various embodiments discussed above are not routine, or conventional, or well understood in the art. The pre-processing techniques disclosed may clean and enhance the document image without losing information. Further, the contour-based localization techniques may the find the bounding boxes for the selection elements. Further, the multi-filtering techniques may reduce false positive before final localization and classification. Further, the techniques may reduce reliance of deep neural network with the help of contouring method for localization of checkboxes or radio buttons. The techniques may reduce the memory usage and time to process with equal or better performance than a fully deep neural network approach.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for automatic detection of selection elements in digitized documents The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for automatic detection of selection elements in digitized documents, the method comprising:
receiving, by a computing device, a document image comprising a plurality of elements, wherein the plurality of elements comprises a plurality of selection elements, and wherein each of the plurality of selection elements is one of a checkbox or a radio button;
extracting, by the computing device, a plurality of contours corresponding to the plurality of elements in the document image using a contour extraction technique;
eliminating, by the computing device, a first set of false positive selection elements from the plurality of contours using one or more contour filters to obtain a plurality of filtered contours; and
determining, by the computing device via a Convolution Neural Network (CNN) model, the plurality of selection elements and a selection state corresponding to each of the plurality of selection elements, from the plurality of filtered contours, wherein the selection state corresponds to one of selected or unselected.

2. The method of claim 1, further comprising:
determining, via a quality assessment model, a quality category of the document image based on a set of quality parameters of the document image; and
pre-processing, via the quality assessment model, the document image using one or more preprocessing techniques based on the quality category to obtain a pre-processed document image.

3. The method of claim 2, wherein determining the quality category of the document image comprises:
determining, via the quality assessment model, a set of quality parameters for the document image, wherein the set of quality parameters comprises Dots Per Inch (DPI), blur, sharpness, contrast, colour, resolution, and noise;
comparing the set of quality parameters with a corresponding set of quality threshold values; and
classifying the document image into one of a good quality image, a medium quality image, or a bad quality image based on the comparing.

4. The method of claim 2, wherein the one or more preprocessing techniques comprise gray scale conversion, noise reduction and smoothening, skew detection and correction, morphological open operation, and applied thresholding.

5. The method of claim 1, wherein extracting the plurality of contours comprises identifying a location of each of the plurality of contours, wherein the location corresponds to position coordinates of each of the corresponding plurality of elements, and wherein each of the plurality of contours comprises a set of points that defines an element.

6. The method of claim 1, wherein eliminating the first set of false positive selection elements comprises:
sequentially applying the one or more contour filters to each of the plurality of elements; and
identifying the first set of false positive selection elements from the plurality of elements based on a predefined threshold of each of the one or more contour filters.

7. The method of claim 1, wherein the one or more contour filters comprise at least one of a polygonal curve count filter, a bounding box aspect ratio filter, a bounding box size filter, a bounding box area filter, a bounding box orientation filter, a nearest neighbour bounding box elimination filter, an inner contour removal filter, and a dynamic area filter.

8. The method of claim 1, further comprising eliminating, via the CNN model, a second set of false positive selection elements from the plurality of filtered contours, prior to determining the plurality of selection elements.

9. A system for automatic detection of selection elements in digitized documents, the system comprising:
a processor; and
a memory communicatively coupled to the processor, wherein the memory stores processor instructions, which when executed by the processor, cause the processor to:
receive a document image comprising a plurality of elements, wherein the plurality of elements comprises a plurality of selection elements, and wherein each of the plurality of selection elements is one of a checkbox or a radio button;
extract a plurality of contours corresponding to the plurality of elements in the document image using a contour extraction technique;
eliminate a first set of false positive selection elements from the plurality of contours using one or more contour filters to obtain a plurality of filtered contours; and
determine, via a Convolution Neural Network (CNN) model, the plurality of selection elements and a selection state corresponding to each of the plurality of selection elements, from the plurality of filtered contours, wherein the selection state corresponds to one of selected or unselected.

10. The system of claim 9, wherein the processor instructions, on execution, further cause the processor to:
determine, via a quality assessment model, a quality category of the document image based on a set of quality parameters of the document image; and
pre-process, via the quality assessment model, the document image using one or more preprocessing techniques based on the quality category to obtain a pre-processed document image.

11. The system of claim 10, wherein to determine the quality category of the document, the processor instructions, on execution, further cause the processor to:
determine, via the quality assessment model, a set of quality parameters for the document image, wherein the set of quality parameters comprises Dots Per Inch (DPI), blur, sharpness, contrast, colour, resolution, and noise;
compare the set of quality parameters with a corresponding set of quality threshold values; and
classify the document image into one of a good quality image, a medium quality image, or a bad quality image based on the comparing

12. The system of claim 10, wherein the one or more preprocessing techniques comprise gray scale conversion, noise reduction and smoothening, skew detection and correction, morphological open operation, and applied thresholding.

13. The system of claim 9, wherein to extract the plurality of contours, the processor instructions, on execution, further cause the processor to identify a location of each of the plurality of contours, wherein the location corresponds to position coordinates of each of the corresponding plurality of elements, and wherein each of the plurality of contours comprises a set of points that defines an element.

14. The system of claim 9, wherein to eliminate the first set of false positive selection elements, the processor instructions, on execution, further cause the processor to:
sequentially apply the one or more contour filters to each of the plurality of elements; and
identify the first set of false positive selection elements from the plurality of elements based on a predefined threshold of each of the one or more contour filters.

15. The system of claim 9, wherein the one or more contour filters comprise at least one of a polygonal curve count filter, a bounding box aspect ratio filter, a bounding box size filter, a bounding box area filter, a bounding box orientation filter, a nearest neighbour bounding box elimination filter, an inner contour removal filter, and a dynamic area filter.

16. The system of claim 9, wherein the processor instructions, on execution, further cause the processor to eliminate, via the CNN model, a second set of false positive selection elements from the plurality of filtered contours, prior to determining the plurality of selection elements.

17. A non-transitory computer-readable medium storing computer-executable instructions for automatic detection of selection elements in digitized documents, the computer-executable instructions configured for:
receiving a document image comprising a plurality of elements, wherein the plurality of elements comprises a plurality of selection elements, and wherein each of the plurality of selection elements is one of a checkbox or a radio button;
extracting a plurality of contours corresponding to the plurality of elements in the document image using a contour extraction technique;
eliminating a first set of false positive selection elements from the plurality of contours using one or more contour filters to obtain a plurality of filtered contours; and
determining, via a Convolution Neural Network (CNN) model, the plurality of selection elements and a selection state corresponding to each of the plurality of selection elements, from the plurality of filtered contours, wherein the selection state corresponds to one of selected or unselected

18. The non-transitory computer-readable medium of claim 17, wherein the computer-executable instructions are further configured for:
determining, via a quality assessment model, a quality category of the document image based on a set of quality parameters of the document image; and
pre-processing, via the quality assessment model, the document image using one or more preprocessing techniques based on the quality category to obtain a pre-processed document image.

19. The non-transitory computer-readable medium of claim 18, wherein to determine the quality category of the document image, the computer-executable instructions are further configured for:
determining, via the quality assessment model, a set of quality parameters for the document image, wherein the set of quality parameters comprises Dots Per Inch (DPI), blur, sharpness, contrast, colour, resolution, and noise;
comparing the set of quality parameters with a corresponding set of quality threshold values; and
classifying the document image into one of a good quality image, a medium quality image, or a bad quality image based on the comparing.

20. The non-transitory computer-readable medium of claim 18, wherein the one or more preprocessing techniques comprise gray scale conversion, noise reduction and smoothening, skew detection and correction, morphological open operation, and applied thresholding.
